(19) United States
(12) Patent Application Publication
(10) Pub. No.: US 2017/0056820 A1
(43) Pub. Date: Mar. 2, 2017

(54) METHOD AND APPARATUS FOR PURIFYING A GAS CONTAINING POLLUTANTS

(71) Applicant: UGRA S.R.L., Judentul - Timis (RO)

(72) Inventor: Mario Fabbri, Judentul - Timis (RO)

(73) Assignee: UGRA S.R.L., Judentul- Timis (RO)

(21) Appl. No.: 15/119,957

(22) PCT Filed: Feb. 17, 2015
(86) PCT No.: PCT/IB2015/000363

§ 371 Date: Aug. 18, 2016

(30) Foreign Application Priority Data
Feb. 18, 2014 (IT) MO2014A000037

(51) Int. Cl. B01D 53/32; B01D 46/00; B01D 53/78; B01D 53/38; B01D 53/62

(52) U.S. Cl. CPC B01D 53/32; B01D 53/38; B01D 53/62; B01D 53/78; B01D 46/0027; B01D 2259/818; B01D 2252/103; B01D 2257/504; B01D 2258/0283; B01D 2258/02

(57) ABSTRACT

The method for the purification of a gas containing pollutants, particularly fumes, comprising the following steps of:

providing a purification apparatus comprising a hollow body defining a purification chamber;

feeding of a gas to be purified inside the purification chamber;

first dispensing operation of nebulized water inside a first portion of the purification chamber to intercept the gas to be purified for the abatement of the organic and/or inorganic compounds present in the gas itself;

treatment of the gas coming out of the first portion in a second portion arranged downstream of the first portion in the direction of gas flow;

second dispensing operation of nebulized water inside a third portion of the purification chamber, arranged downstream of the second portion in the direction of gas flow;

where nebulized water comprises deuterium and where the treatment comprises the formation of electric discharges in the second portion to ionize the gas coming out of the first portion and to obtain a state of plasma, the formation of electric discharges taking place between at least a pair of electrodes arranged inside the second portion and powered with a pulsating direct current having a voltage between 24,000 volts and 28,000 volts and an amperage between 0.1 A and 1.5 A and being able to cause the molecular dissociation of the organic compounds present in the gas to be purified.

### TECHNICAL FIELD

The present invention relates to a method and an apparatus for the purification of exhaust gases containing pollutants, particularly fumes.

### BACKGROUND ART

As is known, the need continues to be very much felt to treat gas containing pollutants such as, e.g., the fumes from combustion plants or the wastewaters from industrial processes containing both organic and inorganic pollutants, such as particulate and heavy metals.

Equally important, from both an economic and environmental viewpoint, is the abatement of the CO2 contained in the above exhaust gases.

For obvious environmental reasons, such pollutants must be disposed of before the gas is emitted into the atmosphere.

In the case of gas containing mainly organic pollutants, the purification process is generally performed by means of combustion.

More in detail, the gas is introduced into a combustion chamber containing a flame suitably kept alight by a fuel and within which waste product oxidization occurs.

This known gas purification method does however have a number of drawbacks, tied in particular to the high consumption of fuel, to the presence of partially oxidized components in the exiting fumes, to the long time it takes to make the method operative and to the lack of flexibility in case of variable load conditions.

In the case, instead, of the gas to be purified containing in particular pollutants of an inorganic nature, such as ashes, metals, in particular heavy metals and or particulates, purification is normally done using equipment that includes selective filters, washing systems and electro-filters. A further drawback also regards the cleaning and disposal of these electro-filters and their waste product. It is also underlined that the effectiveness of such filters is gradually reduced with use, until the cleaning or complete replacement of same becomes indispensable along with their subsequent disposal in a rubbish dump.

This type of equipment however has large overall dimensions and requires high investment, running and maintenance costs.

The documents JP 2000 037638, U.S. Pat. No. 2,730,195, U.S. Pat. No. 4,222,748, EP 0 532 841, GB 556 939 describe gas purification methods which envisage a first water dispensing operation, followed by a gas treatment phase during which the molecules are electro-statically charged and subsequently trapped by means of a sort of electrostatic filter, after which the gas thus treated undergoes a second water dispensing operation.

### DESCRIPTION OF THE INVENTION

The main aim of the present invention is to provide a method and an apparatus for the purification of gases which permits successfully abating the pollutants, both organic and inorganic, contained in the treated gas.

Within this aim, an object of the present invention is to provide a method and an apparatus for the purification of gases containing pollutants having low investment, operating and maintenance costs compared to the methods and equipment of known type currently used.

Another object of the present invention is to provide a method and an apparatus for the purification of gases containing pollutants which allow to overcome the mentioned drawbacks of the prior art within the ambit of a simple, rational, easy, effective to use as well as affordable solution.

The above mentioned objects are achieved by the present method having the characteristics of claim 1.

The above mentioned objects are achieved by the present apparatus having the characteristics of claim 7.

### BRIEF DESCRIPTION OF THE DRAWINGS

Other characteristics and advantages of the present invention will become better evident from the description of a preferred, but not exclusive embodiment of an apparatus for the purification of gases containing pollutants, illustrated by way of an indicative, but not limitative example in the accompanying drawings in which:

FIG. 1 is a longitudinal sectional view of an apparatus according to the invention.

### EMBODIMENTS OF THE INVENTION

With particular reference to such a figure, reference number 1 globally designates an apparatus for the purification of gases containing pollutants.

The apparatus 1 comprises a hollow body 2 defining a purification chamber 3 having an inlet mouth 4 for the gas to be purified and an outlet mouth 5 for the purified gas.

Preferably, the body 2 has a substantially circular section and the inlet and outlet mouths 4, 5 are arranged at its axial extremities.

According to the invention, the apparatus 1 comprises first dispensing means 6 for dispensing nebulized water inside a first portion 3a of the purification chamber 3 for the abatement of the organic and/or inorganic compounds in the gas to be purified. The water nebulized by means of the first dispensing means 6 comprises deuterium, so as to increase the electrical conductivity of the water itself.

More in particular, the first dispensing means 6 comprise a plurality of nozzles arranged at the inner wall of the body 2 delimiting the first portion 3a.

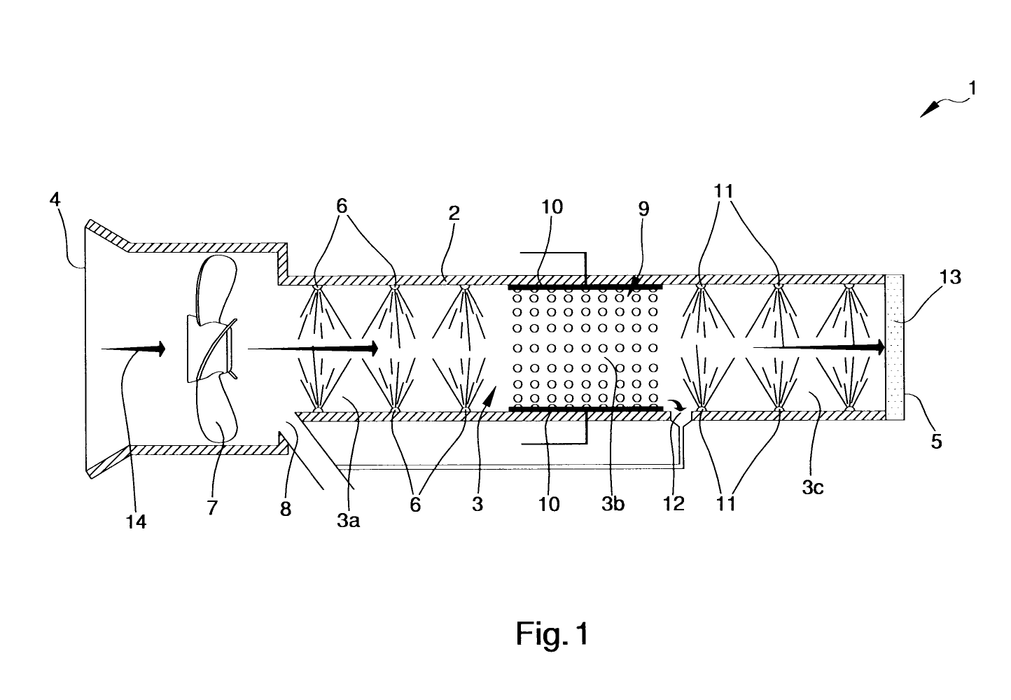

As can be seen from the embodiment shown in FIG. 1, the first dispensing means 6 comprise a plurality of nozzles separated the one from the other along the longitudinal extension of the body 2, e.g., along several rows arranged on opposite sides of the first portion 3a.

Suitably, the direction of the nozzles 6 is adjustable and they are fitted in such a way as to create turbulence inside the chamber and obtain substantially uniform nebulization inside the first portion 3a.

The gas to be purified is introduced inside the body 2 through the inlet mouth 4 in a substantially axial direction and the nebulized water coming out of the nozzles 6 is able to intercept the gas thus introduced crossways to its direction of flow, identified by the arrow 14, inside the purification chamber 3.

Conveniently, the apparatus 1 comprises at least an axial fan 7 arranged in the proximity of the inlet mouth 4 and able to define a vacuum for the aspiration of the gas inside the hollow body 2.

The water injected through the nozzles 6 is at room temperature, preferably not below 10° C., and is supplied at a pressure (about 30/40 bar) such as to allow the complete nebulization of the water inside the first portion 3a and not hamper the normal outflow of the gas inside the body 2.

Preferably, the water nebulized by the nozzles 6 contains percentages of M.P.C.D. (Molecular Potentially Chain Disintegrator), which comprises at least one chosen from the group: sodium carbonate, sodium metasilicate, ethoxylated alcohol and water dyes, and is able to facilitate the molecular dissociation and favor the precipitation of the organic and/or inorganic parts on the bottom of the body 2.

The organic and/or inorganic parts which are abated as the gas flows through the first portion 3a are collected on the bottom of the body 2, where a first gap 8 is provided to allow the organic and/or inorganic parts themselves to come out along with the washing water formed following the condensation of the nebulized water dispensed by means of the nozzles 6.

The apparatus 1 then comprises gas treatment means in a second portion 3b of the purification chamber 3 and arranged downstream of the first dispensing means 6 with respect to the direction of gas flow. 3b. According to the invention, the treatment means comprise means for the formation 9 of electric discharges able to cause the ionization of the gas coming out of the first portion 3a and to obtain a state of plasma, thus causing the molecular dissociation of the organic compounds contained in the gas itself, i.e., the separation of the CO₂ and of the other long-chain molecules.

For example, the CO₂ separates according to the following reaction:
CO₂→CO−0.5 O₂

Following such splitting up, the molecules remain in a state of “non-equilibrium”.

The formation means 9 comprise at least a pair of electrodes 10 opposite in sign and means for applying a difference in potential (not shown in the illustration) to such pair of electrodes 10. The electrodes 10, between which the above-mentioned electric discharges occur, receive a pulsating direct current having a voltage between 25,000 volts and 30,000 volts and an amperage between 0.1 A and 1.5 A.

The electric discharges applied in the second portion 3b are therefore able to cause the molecular dissociation of the inorganic compounds and not to electrostatically charge the relative molecules.

Preferably, the electrodes 10 are of the mesh type with metal cage.

In the embodiment in FIG. 1, the second portion 3b has a substantially cylindrical shape and the electrodes 10 are arranged at the inner walls of such second portion 3b on opposite sides of same.

The number of electrodes 10 is suitably selected according to the flow rate (m3/h) of the gas to be treated.

The distance between each pair of electrodes 10 is also selected according to the elements making up the gas to be treated and is in any case selected so it is below or equal to 20 mm.

Downstream of the electrodes 10, with respect to the direction of flow of the gas to be treated, second dispensing means 11 of nebulized water are arranged inside a third portion 3c of the purification chamber 3.

The second dispensing means 11 are able to abate from the gas coming out of the second portion 3b the further molecular residues remaining following the dissociation caused by the ionization.

More in detail, the second dispensing means 11 comprise a plurality of nozzles arranged at the inner walls of the body 2 delimiting the third portion 3c.

In this case as well, the direction of nozzles 11 can be adjusted and these are fitted in such a way as to create turbulence inside the chamber and obtain substantially uniform nebulization inside the third portion 3c.

The nozzles 11 are able to introduce nebulized water inside the third portion 3c at room temperature, so as to further abate the molecules still in suspension in order to avoid recreating original molecules or other long-chain molecules, such as furans or dioxins.

Just like the first dispensing means 6, the nozzles 11 are also arranged along several rows facing and opposing one another.

Preferably, the nebulized water from the nozzles 11 contains percentages of M.P.C.D. which, in this case too, is able to favor the precipitation of the organic and/or inorganic parts contained in the long-chain molecules and the exit of water vapor only with a high content of oxygen and ozone.

The precipitated organic and/or inorganic parts are collected up on the bottom of the body 2 and come out, along with the washing water dispensed by the nozzles 11, through a second gap 12 placed between the second and the third portions 3b and 3c and communicating with the first gap 8.

Advantageously, the apparatus 1 also comprises at least a filtering element 13 arranged downstream of the second dispensing means 11 and able to trap any solid particles still remaining in the gas after this has flowed through the third portion 3c.

In the embodiment shown in FIG. 1, the filtering element 13 is arranged at the outlet mouth 5.

More in particular, the filtering element 13 is of the mechanical type and comprises one or more layers of fabric, preferably in carbon fiber.

The apparatus 1 can also comprise an axial fan, not shown in the illustration, able to facilitate the outflow of gas through the purification chamber 3.

The operation of the present invention is as follows.

The gas to be purified is fed inside the purification chamber 3 through the inlet mouth 4 and the axial fan 7 guides its outflow along the direction 14.

The gas to be purified then arrives at the first portion 3a, where the first dispensing operation of nebulized water comprising deuterium takes place by means of the nozzles 6.

As has been said above, the nebulized water dispensed by the nozzles 6, preferably at room temperature, causes the abatement of the organic and/or inorganic components contained in the gas to be purified, which collect up on the bottom of the first portion 3a, from where they are removed.

Subsequently, the gas reaches the second portion 3b of the purification chamber 3 where, due to the effect of the electric discharges created between the electrodes 10 following the difference in potential applied to same, the ionization occurs of the gas itself, which reaches a state of plasma.

By effect of the high humidity content of the gas and of its high electrical conductivity, due to the washing performed in the first portion 3a and to the presence of deuterium in the water dispensed by means of the nozzles 6, the circuit is closed between the electrodes 10, which consequently produce a series of high-voltage electric discharges. The electric discharges thus produced cause the molecular dissociation of the organic compounds, such as carbon dioxide and the other long-chain molecules.

Following the ionization that occurs in the second portion 3b, the split-up molecules remain in a state of “non equilibrium”.

Downstream of the second portion 3b, a second dispensing operation of nebulized water then takes place, substantially according to the same procedures as the first dispensing operation mentioned above, in order to further abate the molecules still in suspension and prevent the reforming of the original molecules or other long-chain molecules.

This second “washing” causes the further abatement of the organic and/or inorganic components still contained in the gas, which precipitate and collect up on the bottom of the purification chamber 3.

The organic and/or inorganic parts which have precipitated, both following the first and the second dispensing operations of nebulized water, are conveyed into a recovery channel through the gaps 8 and 12.

Preferably, the gas that comes out of the third portion 3c also undergoes a phase of mechanical filtration able to trap any impurities still remaining in the gas.

More in detail, the gas crosses the filtering element 13 placed at the outlet mouth 5.

The gas that comes out of the outlet mouth 5 therefore consists of oxygen, water vapor and ozone.

It has in practice been ascertained how the described invention achieves the proposed objects and in particular the fact is underlined that the method and the apparatus forming the subject of the present invention allow purifying in an easy and practical way the polluted gases, such as those coming from combustion processes or the wastewater of industrial processes containing both organic and inorganic pollutants, and the abatement of CO2.

1. A method for the purification of a gas containing pollutants, particularly fumes, comprising the following steps of:
providing a purification apparatus comprising a hollow body defining a purification chamber having an inlet mouth for the gas to be purified and an outlet mouth for the purified gas;
feeding of a gas to be purified inside said purification chamber through said inlet mouth;
first dispensing operation of nebulized water inside a first portion of said purification chamber to intercept the gas to be purified for the abatement of the organic and/or inorganic compounds present in the gas itself;
treatment of the gas coming out of said first portion in a second portion arranged downstream of said first portion in the direction of gas flow;
second dispensing operation of nebulized water inside a third portion of said purification chamber, arranged downstream of said second portion in the direction of gas flow, for the further abatement of the molecules still in suspension in the gas coming out of the second portion itself;
wherein said nebulized water comprises deuterium and wherein said treatment comprises the formation of electric discharges in said second portion to ionize the gas coming out of the first portion and to obtain a state of plasma, said formation of electric discharges taking place between at least a pair of electrodes arranged inside said second portion and powered with a pulsating direct current having a voltage between 24,000 volts and 28,000 volts and an amperage between 0.1 A and 1.5 A and being able to cause the molecular dissociation of the organic compounds present in the gas to be purified.

2. The method according to claim 1, wherein said electric discharges are not able to charge electro-statically the molecules contained in the gas coming out of said first portion.

3. The method according to claim 1, wherein the water nebulized by means of said first and said second dispensing operation is at room temperature.

4. The method according to claim 1, wherein the water nebulized with said first and/or with said second dispensing operation comprises M.P.C.D.

5. The method according to claim 1, wherein it comprises a phase of mechanical filtration of the gas that comes out of said third portion.

6. The method according to claim 5, wherein said phase of filtration is carried out by means of a filtering element arranged at said outlet mouth and comprising carbon fiber.

7. An apparatus for the purification of a gas containing pollutants, particularly fumes, comprising:
a hollow body defining a purification chamber having an inlet mouth for the gas to be purified and an outlet mouth for the purified gas;
first dispensing means of nebulized water inside a first portion of said purification chamber for the abatement of the organic and/or inorganic compounds present in the gas to be purified;
treatment means of the gas inside a second portion of said purification chamber and arranged downstream of said first dispensing means in the direction of gas flow;
second dispensing means of nebulized water inside a third portion of said purification chamber and arranged downstream of said means for the formation of electric discharges, said second dispensing means being able to further abate the molecules still in suspension in the gas coining out of said second portion;
wherein said treatment means comprise means for the formation of electric discharges able to ionize the gas coming out of said first portion to obtain a state of plasma, said formation of electric discharges taking place between at least a pair of electrodes arranged inside said second portion and powered with a pulsating direct current having a voltage between 24,000 volts and 28,000 volts and an amperage between 0.1 A and 1.5 A, so as to cause the molecular dissociation of the organic compounds present in the gas to be purified.

8. The apparatus according to claim 7, wherein at least one of said first and said second dispensing means comprises a plurality of nozzles arranged at the walls of said hollow body delimiting said first and said third portion, respectively.

9. The apparatus according to claim 7, wherein said second portion has a substantially cylindrical shape and that said electrodes are of the mesh type with metal cage.

10. The apparatus according to claim 7, wherein the electrodes of said at least one pair are arranged at a distance below or equal to 20 mm.

11. The apparatus according to claim 7, wherein it comprises at least a filtering element arranged downstream of said second dispensing means.

12. The apparatus according to claim 11, wherein said filtering element comprises one or more layers of fabric comprising carbon fiber.

13. The apparatus according to claim 11, wherein said filtering element is arranged at said outlet mouth.
